(19) United States
(12) Patent Application Publication
(10) Pub. No.: US 2003/0125244 A1
(43) Pub. Date: Jul. 3, 2003

(54) Endoparasiticidal agents

(76) Inventors: Jochen Kalbe, Leichlingen (DE); Michael Traubel, Koln (DE); Georg von-Samson-Himmelstjerna, Mellendorf (DE); Achim Harder, Koln (DE); Michael Stegemann, Plesaunce (GB); Norbert Mencke, Leverkusen (DE)

Correspondence Address: JEFFREY M. GREENMAN, VICE PRESIDENT, PATENTS AND LICENSING, BAYER CORPORATION, 400 MORGAN LANE, WEST HAVEN, CT, 06516, US

(21) Appl. No.: 10/204,880

(22) PCT Filed: Feb. 9, 2001
(86) PCT No.: PCT/EP01/01392

(30) Foreign Application Priority Data
Feb. 22, 2000 (DE) 100 08 128.2

(51) Int. Cl. A01N 43/00

(52) U.S. Cl. 514/9; 514/183

(57) ABSTRACT

The present invention provides topically administrable endoparasiticidal compositions comprising cyclic and open-chain depsipeptides consisting of amino acid and hydroxycarboxylic acid building blocks and containing 6 to 30 ring or chain atoms, their preparation and their use as endoparasiticides.

The present invention relates to transdermally administrable compositions comprising cyclic depsipeptides, to their preparation and to their use for controlling endoparasites.

A cyclic depsipeptide PF1022 and its action against endoparasites is known from EP-A 382 173.

Further cyclic depsipeptides and their endoparasiticidal action are the subject of the German patent applications DE-A 4 317 432.9; DE-A 4 317 457.4; DE-A 4 317 458.2.

The U.S. Pat. No. 3,004,894 describes compositions comprising compounds with antibiotic action, for use by injection. Accordingly, these compositions differ fundamentally from the compositions according to the invention.

Enhancers for transdermal penetration are described in the patent application EP-A 0 268 460. However, these substances are not suitable for use as solvents for depsipeptides and, accordingly, can only be considered for use as a surfactant additive for transdermal compositions.

However, the efficacy and/or the duration of action of the prior-art compositions is, in particular against certain organisms and/or at low application concentrations, not entirely satisfactory in all areas of use.

Owing to the multivarious requirements that modern drugs have to meet, for example with respect to efficacy, duration of action, activity spectrum, use spectrum, toxicity, combination of active compounds, combination with formulation auxiliaries and the possibility of resistance, the development of novel drugs is a never-ending task, and there is a constant great need for novel compositions which, at least in some aspects, have advantages compared to the compositions of the prior art.

To make the administration of endoparasiticidally active compounds as easy as possible to the animal keeper, it is furthermore desirable to provide a composition which can be administered transdermally.

As is known from the literature, in the case of topical administration, it is extremely difficult for molecules having molecular weights >1000 u to penetrate the skin. Penetration is particularly difficult for peptides or proteins having relatively high molecular weights (Cevc et al, Exp. Opin. Invest Drugs 1997 6, 12; Pharmazeutische Technologie, Bauer, Frömming, Führer, 1993, p. 364, Thieme Verlag; Gurny, Teubner, Dermal and Transdermal Drug Delivery, 1993, p. 131, Wissenschaftliche Verlagsgesellschaft). However, for endoparasiticidally active compounds, penetration is a prerequisite, since the compounds are to act against endoparasites in the gastrointestinal tract.

The present invention provides endoparasiticidal compositions which can be administered topically and transdermally and which comprise cyclodepsipeptides consisting of amino acid and hydroxycarboxylic acid building blocks and containing 6 to 30 ring or chain atoms.

Surprisingly, it has now been found that the depsipeptides mentioned above (with molecular weights >1000 u) show complete pharmaceutical activity when they are applied topically, in the form of the compositions according to the invention, to animals, such as, for example, dogs or cats.

Furthermore, it was surprising that the depsipeptides in the compositions according to the invention show long-lasting stability, whereas they are degraded extremely rapidly in the known topical formulations (as described, for example, in EP A 0 682 869).

Moreover, in contrast to the known compositions, the compositions according to the invention show complete biological activity.

The present invention provides:

1. Compositions, comprising cyclic depsipeptides on their own or as a mixture with other active compounds, characterized in that they comprise a solvent or a solvent mixture and that these compositions are suitable for topical administration in animals.

2. Compositions according to item 1, characterized in that they comprise 1,2-isopropylideneglycerol.

3. Compositions according to item 1, characterized in that they comprise 1,2-isopropylideneglycerol and benzyl alcohol and/or propylene glycol diacetate.

4. Compositions according to item 1, characterized in that they comprise benzyl alcohol and propylene glycol diacetate.

The present invention furthermore provides the preparation of topically administrable endoparasiticidal compositions comprising cyclic depsipeptides consisting of amino acid and hydroxycarboxylic acid ring components and containing 6 to 30 ring or chain atoms.

Preferred cyclic depsipeptides are those having 18-24 ring atoms, in particular having 24 ring atoms.

The depsipeptides having 18 ring atoms include compounds of the general formula (I):

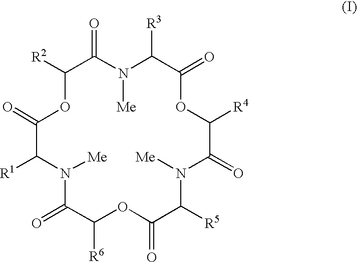

in which

R¹, R³ and R⁵ independently of one another represent hydrogen, straight-chain or branched alkyl having up to 8 carbon atoms, hydroxyalkyl, alkanoyloxyalkyl, alkoxyalkyl, aryloxyalkyl, mercaptoalkyl, alkylthioalkyl, alkylsulphinylalkyl, alkylsulphonylalkyl, carboxyalkyl, alkoxycarbonylalkyl, arylalkoxycarbonylalkyl, carbamoylalkyl, aminoalkyl, alkylaminoalkyl, dialkylaminoalkyl, guanidinoalkyl which may optionally be substituted by one or two benzyloxycarbonyl radicals or by one, two, three or four alkyl radicals, alkoxycarbonylaminoalkyl, 9-fluorenylmethoxycarbonyl(Fmoc)aminoalkyl, alkenyl, cycloalkyl, cycloalkylalkyl and optionally substituted arylalkyl, possible substituents being halogen, hydroxyl, alkyl and alkoxy,

R², R⁴ and R⁶ independently of one another represent hydrogen, straight-chain or branched alkyl having up to 8 carbon atoms, hydroxyalkyl, mercaptoalkyl, alkanoyloxyalkyl, alkoxyalkyl, aryloxyalkyl, alkylthioalkyl, alkylsulphinylalkyl, alkylsulphonylalkyl, carboxyalkyl, alkoxycarbonylalkyl, arylalkoxycarbonylalkyl, carbamoylalkyl, aminoalkyl, alkylaminoalkyl, dialkylaminoalkyl, alkoxycarbonylaminoalkyl, alkenyl, cycloalkyl, cycloalkylalkyl, optionally substituted aryl or arylalkyl, possible substituents being halogen, hydroxyl, alkyl, alkoxy,

and their optical isomers and racemates.

Preference is given to compounds of formula (I),

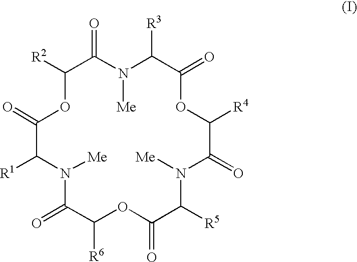

in which

R¹, R³ and R⁵ independently of one another represent straight-chain or branched C₁-C₈-alkyl, in particular methyl, ethyl, propyl, isopropyl, butyl, isobutyl, sec-butyl, tert-butyl, pentyl, isopentyl, sec-pentyl, hexyl, isohexyl, sec-hexyl, heptyl, isoheptyl, sec-heptyl, tert-heptyl, octyl, isooctyl, sec-octyl, hydroxy-C₁-C₆-alkyl, in particular hydroxymethyl, 1-hydroxyethyl, C₁-C₄-alkanoyloxy-C₁-C₆-alkyl, in particular acetoxymethyl, 1-acetoxyethyl, C₁-C₄-alkoxy-C₁-C₆-alkyl, in particular methoxymethyl, 1-methoxyethyl, aryl-C₁-C₄-alkyloxy-C₁-C₆-alkyl, in particular benzyloxymethyl, 1-benzyloxyethyl, mercapto-C₁-C₆-alkyl, in particular mercaptomethyl, C₁-C₄-alkylthio-C₁-C₆-alkyl, in particular methylthioethyl, C₁-C₄-alkylsulphinyl-C₁-C₆-alkyl, in particular methylsulphinylethyl, C₁-C₄-alkylsulphonyl-C₁-C₆-alkyl, in particular methylsulphonylethyl, carboxy-C₁-C₆-alkyl, in particular carboxymethyl, carboxyethyl, C₁-C₄-alkoxycarbonyl-C₁-C₆-alkyl, in particular methoxycarbonylmethyl, ethoxycarbonylethyl, C₁-C₄-arylalkoxycarbonyl-C₁-C₆-alkyl, in particular benzyloxycarbonylmethyl, carbamoyl-C₁-C₆-alkyl, in particular carbamoylmethyl, carbamoylethyl, amino-C₁-C₆-alkyl, in particular aminopropyl, aminobutyl, C₁-C₄-alkylamino-C₁-C₆-alkyl, in particular methylaminopropyl, methylaminobutyl, C₁-C₄-dialkylamino-C₁-C₆-alkyl, in particular dimethylaminopropyl, dimethylaminobutyl, guanidino-C₁-C₆-alkyl, in particular guanidinopropyl, C₁-C₄-alkoxycarbonylamino-C₁-C₆-alkyl, in particular tert-butoxycarbonylaminopropyl, tert-butoxycarbonylaminobutyl, 9-fluorenylmethoxycarbonyl(Fmoc)amino-C₁-C₆-alkyl, in particular 9-fluorenyl-methoxycarbonyl(Fmoc)aminopropyl, 9-fluorenylmethoxycarbonyl(Fmoc)aminobutyl, C₂-C₈-alkenyl, in particular vinyl, allyl, butenyl, C₃-C₇-cycloalkyl, in particular cyclopentyl, cyclohexyl, cycloheptyl, C₃-C₇-cycloalkyl-C₁-C₄-alkyl, in particular cyclopentylmethyl, cyclohexylmethyl, cycloheptylmethyl, phenyl-C₁-C₄-alkyl, in particular phenylmethyl, which may optionally be substituted by radicals from the group consisting of halogen, in particular fluorine, chlorine, bromine or iodine, hydroxyl, C₁-C₄-alkoxy, in particular methoxy or ethoxy, C₁-C₄-alkyl, in particular methyl,

R², R⁴ and R⁶ independently of one another represent straight-chain or branched C₁-C₈-alkyl, in particular methyl, ethyl, propyl, isopropyl, butyl, isobutyl, sec-butyl, tert-butyl, pentyl, isopentyl, sec-pentyl, hexyl, isohexyl, sec-hexyl, heptyl, isoheptyl, sec-heptyl, tert-heptyl, octyl, isooctyl, sec-octyl, hydroxy-C₁-C₆-alkyl, in particular hydroxymethyl, 1-hydroxyethyl, C₁-C₄-alkanoyloxy-C₁-C₆-alkyl, in particular acetoxymethyl, 1-acetoxyethyl, C₁-C₄-alkoxy-C₁-C₆-alkyl, in particular methoxymethyl, 1-methoxyethyl, aryl-C₁-C₄-alkyloxy-C₁-C₆-alkyl, in particular benzyloxymethyl, 1-benzyloxyethyl, mercapto-C₁-C₆-alkyl, in particular mercaptomethyl, C₁-C₄-alkylthio-C₁-C₆-alkyl, in particular methylthioethyl, C₁-C₄-alkylsulphinyl-C₁-C₆-alkyl, in particular methylsulphinylethyl, C₁-C₄-alkylsulphonyl-C₁-C₆-alkyl, in particular methylsulphonylethyl, carboxy-C₁-C₆-alkyl, in particular carboxymethyl, carboxyethyl, C₁-C₄-alkoxycarbonyl-C₁-C₆-alkyl, in particular methoxycarbonylmethyl, ethoxycarbonylethyl, C₁-C₄-arylalkoxycarbonyl-C₁-C₆-alkyl, in particular benzyloxycarbonylmethyl, carbamoyl-C₁-C₆-alkyl, in particular carbamoylmethyl, carbamoylethyl, amino-C₁-C₆-alkyl, in particular aminopropyl, aminobutyl, C₁-C₄-alkylamino-C₁-C₆-alkyl, in particular methylaminopropyl, methylaminobutyl, C₁-C₄-dialkylamino-C₁-C₆-alkyl, in particular dimethylaminopropyl, dimethylaminobutyl, C₂-C₈-alkenyl, in particular vinyl, allyl, butenyl, C₃-C₇-cycloalkyl, in particular cyclopentyl, cyclohexyl, cycloheptyl, C₃-C₇-cycloalkyl-C₁-C₄-alkyl, in particular cyclopentylmethyl, cyclohexylmethyl, cycloheptylmethyl, phenyl, phenyl-C₁-C₄-alkyl, in particular phenylmethyl, which may optionally be substituted by radicals from the group consisting of halogen, in particular fluorine, chlorine, bromine or iodine, hydroxyl, C₁-C₄-alkoxy, in particular methoxy or ethoxy, C₁-C₄-alkyl, in particular methyl,

and their optical isomers and racemates.

Particular preference is given to compounds of the formula (I),

in which

R¹, R³ and R⁵ independently of one another represent straight-chain or branched C₁-C₈-alkyl, in particular methyl, ethyl, propyl, isopropyl, butyl, isobutyl, sec-butyl, pentyl, isopentyl, sec-pentyl, hexyl, isohexyl, sec-hexyl, heptyl, isoheptyl, sec-heptyl, octyl, isooctyl, sec-octyl, hydroxy-C₁-C₆-alkyl, in particular hydroxymethyl, 1-hydroxyethyl, C₁-C₄-alkanoyloxy-C₁-C₆-alkyl, in particular acetoxymethyl, 1-acetoxyethyl, C₁-C₄-alkoxy-C₁-C₆-alkyl, in particular methoxymethyl, 1-methoxyethyl, aryl-C₁-C₄-alkyloxy-C₁-C₆-alkyl, in particular benzyloxymethyl, 1-benzyloxyethyl, C₁-C₄-alkoxycarbonylamino-C₁-C₆-alkyl, in particular tert-butoxycarbonylaminopropyl, tert-butoxycarbonylaminobutyl, C₂-C₈-alkenyl, in particular vinyl, allyl, C₃-C₇-cycloalkyl, in particular cyclopentyl, cyclohexyl, cycloheptyl, C₃-C₇-cycloalkyl-C₁-C₄-alkyl, in particular cyclopentylmethyl, cyclohexylmethyl, cycloheptylmethyl, phenyl-C₁-C₄-alkyl, in particular phenylmethyl, which may optionally be substituted by one or more identical or different of the abovementioned radicals,

R², R⁴ and R⁶ independently of one another represent straight-chain or branched C₁-C₈-alkyl, in particular methyl, ethyl, propyl, isopropyl, butyl, isobutyl, sec-butyl, tert-butyl, pentyl, isopentyl, sec-pentyl, hexyl, isohexyl, sec-hexyl, heptyl, isoheptyl, sec-heptyl, tert-heptyl, octyl, isooctyl, sec-octyl, hydroxy-C₁-C₆-alkyl, in particular hydroxymethyl, aryl-C₁-C₄-alkyloxy-C₁-C₆-alkyl, in particular benzyloxymethyl, 1-benzyloxyethyl, carboxy-C₁-C₆-alkyl, in particular carboxymethyl, carboxyethyl, C₁-C₄-alkoxycarbonyl-C₁-C₆-alkyl, in particular methoxycarbonylmethyl, ethoxycarbonylethyl, C₁-C₄-aryl-alkoxycarbonyl-C₁-C₆-alkyl, in particular benzyloxycarbonylmethyl, C₁-C₄-alkylamino-C₁-C₆-alkyl, in particular methylaminopropyl, methylaminobutyl, C₁-C₄-dialkylamino-C₁-C₆-alkyl, in particular dimethylaminopropyl, dimethylaminobutyl, C₂-C₈-alkenyl, in particular vinyl, allyl, butenyl, C₃-C₇-cycloalkyl, in particular cyclopentyl, cyclohexyl, cycloheptyl, C₃-C₇-cycloalkyl-C₁-C₄-alkyl, in particular cyclopentylmethyl, cyclohexylmethyl, cycloheptyl-methyl, phenyl, phenyl-C₁-C₄-alkyl, in particular phenylmethyl, which may optionally be substituted by one or more identical or different of the abovementioned radicals,

and their optical isomers and racemates.

Very particular preference is given to compounds of the formula (I), in which

R¹, R³ and R⁵ independently of one another represent straight-chain or branched C₁-C₈-alkyl, in particular methyl, ethyl, propyl, isopropyl, butyl, isobutyl, sec-butyl, pentyl, isopentyl, sec-pentyl, hexyl, isohexyl, sec-hexyl, heptyl, isoheptyl, sec-heptyl, octyl, isooktyl, sec-octyl, C₂-C₈-alkenyl, in particular allyl, C₃-C₇-cycloalkyl-C₁-C₄-alkyl, in particular cyclohexylmethyl, phenyl-C₁-C₄-alkyl, in particular phenylmethyl,

R², R⁴ and R⁶ independently of one another represent straight-chain or branched C₁-C₈-alkyl, in particular methyl, ethyl, propyl, isopropyl, butyl, isobutyl, sec-butyl, pentyl, isopentyl, sec-pentyl, hexyl, isohexyl, sec-hexyl, heptyl, isoheptyl, sec-heptyl, octyl, isooctyl, sec-octyl, C₂-C₈-alkenyl, in particular vinyl, allyl, C₃-C₇-cycloalkyl-C₁-C₄-alkyl, in particular cyclohexylmethyl, phenyl-C₁-C₄-alkyl, in particular phenylmethyl, which may optionally be substituted by one or more identical or different of the abovementioned radicals,

and their optical isomers and racemates.

For the purpose of the present invention, it is possible to use all compounds of the general formula (I) which may be present in optically active stereoisomeric forms or as racemic mixtures. However, preference is given to using, according to the invention, the optically active stereoisomeric forms of the compounds of the general formula (I).

Specifically, the following compounds of the general formula (I) may be mentioned, in which

the radicals R¹ to R⁶ are as defined below:

| | |
|---|---|
| | (I) |
| 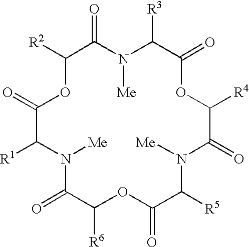 | |

| R¹ | R² | R³ | R⁴ | R⁵ | R⁶ |
|---|---|---|---|---|---|
| —CHMeCH₂Me | -cyclohexyl | —CHMeCH₂Me | —Me | —CHMeCH₂Me | —Me |
| —CHMeCH₂Me | -cyclohexyl | —CHMeCH₂Me | —Me | —CHMeCH₂Me | -cyclohexyl |
| —CHMeCH₂Me | —CH₂—Phe | —CHMeCH₂Me | —Me | —CHMeCH₂Me | —Me |
| —CHMeCH₂Me | —CH₂—Phe | —CHMeCH₂Me | —Me | —CHMeCH₂Me | —CH₂—Phe |
| —CHMeCH₂Me | —(CH₂)₃—Me | —CHMeCH₂Me | —Me | —CHMeCH₂Me | —Me |
| —CHMeCH₂Me | —(CH₂)₃—Me | —CHMeCH₂Me | —Me | —CHMeCH₂Me | —(CH₂)₃—Me |
| —CHMe₂ | —CH₂—Phe | —CHMeCH₂Me | —Me | —CHMeCH₂Me | —Me |
| —CH₂—Phe | —CHMe₂ | —CH₂—Phe | —CHMe₂ | —CHMeCH₂Me | —CHMe₂ |
| —CH₂CHMe₂ | —CH₂—Phe | —CH₂CHMe₂ | —Me | —CH₂CHMe₂ | —CH₂—Phe |
| —(CH₂)₃—Me | —Me | —CHMeCH₂Me | —Me | —CHMeCH₂Me | —Me |
| —CHMe₂ | —Me | —CHMe₂ | —Me | —CHMe₂ | —Me |
| —CH₂—Me | —Me | —CH₂—Me | —Me | —CH₂—Me | —Me |
| —(CH₂)₂—Me | —Me | —(CH₂)₂—Me | —Me | —(CH₂)₂—Me | —Me |
| —(CH₂)₃—Me | —Me | —(CH₂)₃—Me | —Me | —(CH₂)₃—Me | —Me |
| —CH₂—CH═CH₂ | —Me | —CH₂—CH═CH₂ | —Me | —(CH₂)—CH═CH₂ | —Me |
| —CHMeCH₂Me | —Me | —CHMeCH₂Me | —Me | —CHMeCH₂Me | —CH₂—Me |
| —CHMeCH₂Me | —Me | —CHMeCH₂Me | —Me | —CHMeCH₂Me | —(CH₂)₂—Me |
| —CHMeCH₂Me | —Me | —CHMeCH₂Me | —Me | —CHMeCH₂Me | —(CH₂)₃—Me |
| —CHMeCH₂Me | —Me | —CHMeCH₂Me | —Me | —CH₂Me | —Me |
| —CHMeCH₂Me | —Me | —CHMeCH₂Me | —Me | —(CH₂)₂—Me | —Me |
| -cyclohexyl | —Me | -cyclohexyl | —Me | -cyclohexyl | —Me |
| —CH₂CHMe₂ | -cyclohexyl | —CH₂CHMe₂ | —Me | —CH₂CHMe₂ | -cyclohexyl |
| —CH₂CHMe₂ | -cyclohexyl | —CH₂CHMe₂ | —Me | —CH₂CHMe₂ | —Me |
| —CHMeCH₂Me | —CHMe₂ | —CHMeCH₂Me | —CHMe₂ | —CHMeCH₂Me | —Me |
| —CH₂—Phe | —Me | —CH₂—Phe | —Me | —CH₂—Phe | —Me |
| -cyclohexyl | —Me | -cyclohexyl | —Me | -cyclohexyl | —Me |
| —CHMe₂ | —CHMe₂ | —CHMe | —Me | —CHMe₂ | —Me |
| —CHMe₂ | —CHMe₂ | —CHMe₂ | —CHMe₂ | —CHMe₂ | —Me |
| —CH₂—Me | —CHMe₂ | —CH₂Me | —Me | —CH₂—Me | —Me |
| —CH₂—Me | —CHMe₂ | —CHMe₂ | —CHMe₂ | —CH₂—Me | —Me |
| —(CH₂)₂—Me | —CHMe₂ | —(CH₂)₂—Me | —Me | —(CH₂)₂—Me | —Me |
| —(CH₂)₂—Me | —CHMe₂ | —(CH₂)₂—Me | —CHMe₂ | —(CH₂)₂—Me | —Me |
| —(CH₂)₃—Me | —CHMe₂ | —(CH₂)₃—Me | —Me | —(CH₂)₃—Me | —Me |
| —(CH₂)₃—Me | —CHMe₂ | —(CH₂)₃—Me | —CHMe₂ | —(CH₂)₃—Me | —Me |
| —CH₂—CH═CH₂ | —CHMe₂ | —CH₂—CH═CH₂ | —Me | —CH₂—CH═CH₂ | —Me |
| —CH₂—CH═CH₂ | —CHMe₂ | —CH₂—CH═CH₂ | —CHMe₂ | —CH₂—CH═CH₂ | —Me |
| —Me | —Me | —CHMeCH₂Me | —Me | —CH₂—Me | —Me |
| —Me | —Me | —CHMeCH₂Me | —Me | —(CH₂)₃—Me | —Me |

Me = methyl;
Phe = phenyl

Another depsipeptide which may be mentioned is the compound PF 1022 of the formula below, known from EP-A 382 173:

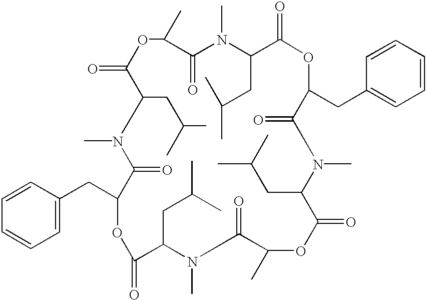

Other depsipeptides which may be mentioned are the compounds known from the PCT application WO 93/19053.

From WO 93/19053 particular mention may be made of the compounds of the following formula:

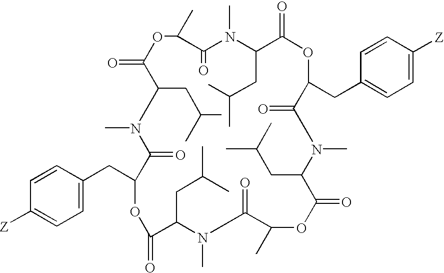

in which

Z represents N-morpholinyl, amino, mono- or dimethylamino.

Among these, in turn, the bis-morpholino derivative (Z=N-morpholinyl) is particularly preferred.

Mention may also be made of compounds of the formula below:

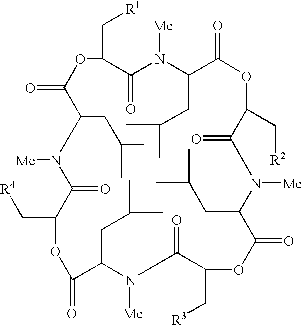

in which

R¹, R², R³, R⁴ independently of one another represent hydrogen, C₁-C₁₀-alkyl or aryl, in particular phenyl, which are optionally substituted by hydroxyl, C₁-C₁₀-alkoxy or halogen.

The compounds of the general formula (I) are known and can be obtained by the processes described in EP-A-382 173, DE-A 4 317 432, DE-A 4 317 457, DE-A 4 317 458, EP-A-634 408, EP-A-718 293, EP-A-872 481, EP-A-685 469, EP-A-626 375, EP-A-664 297, EP-A-669 343, EP-A-787 141, EP-A-865 498, EP-A-903 347.

The cyclic depsipeptides having 24 ring atoms also include compounds of the general formula (Ia)

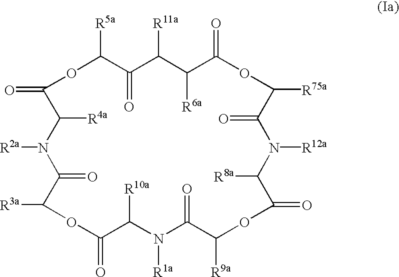

in which

R^{1a}, R^{2a}, R^{11a} and R^{12a} independently of one another represent C₁-C₈-alkyl, C₁-C₈-halogenoalkyl, C₃-C₆-cycloalkyl, aralkyl or aryl,

R^{3a}, R^{5a}, R^{7a}, R^{9a} independently of one another represent hydrogen or straight-chain or branched C₁-C₈-alkyl which may optionally be substituted by hydroxyl, C₁-C₄-alkoxy, carboxyl,

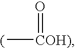

carboxamide,

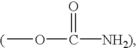

imidazolyl, indolyl, guanidino, —SH or C₁-C₄-alkylthio and furthermore represent aryl or aralkyl which may be substituted by halogen, hydroxyl, C₁-C₄-alkyl, C₁-C₄-alkoxy,

R^{4a}, R^{6a}, R^{8a}, R^{10a} independently of one another represent hydrogen, straight-chain C₁-C₅-alkyl, C₂-C₆-alkenyl, C₃-C₇-cycloalkyl, which may optionally be substituted by hydroxyl, C₁-C₄-alkoxy, carboxyl, carboxamide, imidazolyl, indolyl, guanidino, SH or C₁-C₄-alkylthio, and also represent aryl or aralkyl which may be substituted by halogen, hydroxyl, C₁-C₄-alkyl, or C₁-C₄-alkoxy,

and their optical isomers and racemates.

Preference is given to using compounds of the formula (Ia) in which

R^{1a}, R^{2a}, R^{11a} and R^{12a} independently of one another represent methyl, ethyl, propyl, isopropyl, n-, s-, t-butyl or phenyl which is optionally substituted by halogen, C₁-C₄-alkyl, OH, C₁-C₄-alkoxy, and also represents benzyl or phenylethyl, which may optionally be substituted by the radicals mentioned for phenyl;

R^{3a} to R^{10a} are as defined above.

Particular preference is given to compounds of the formula (Ia), in which

R^{1a}, R^{2a}, R^{11a} and R^{12a} independently of one another represent methyl, ethyl, propyl, isopropyl or n-, s-, t-butyl,

R^{3a}, R^{5a}, R^{7a}, R^{9a} represent hydrogen, straight-chain or branched C₁-C₈-alkyl, in particular methyl, ethyl, propyl, i-propyl, n-, s-, t-butyl, which may optionally be substituted by C₁-C₄-alkoxy, in particular methoxy, ethoxy, imidazolyl, indolyl or C₁-C₄-alkylthio, in particular methylthio, ethylthio, and furthermore represent phenyl, benzyl or phenethyl, which may optionally be substituted by halogen, in particular chlorine,

R^{4a}, R^{6a}, R^{8a}, R^{10a} independently of one another represent hydrogen, methyl, ethyl, n-propyl, n-butyl, vinyl, cyclohexyl, which may optionally be substituted by methoxy, ethoxy, imidazolyl, indolyl, methylthio, ethylthio, and also represent isopropyl, s-butyl, furthermore optionally halogen-substituted phenyl, benzyl or phenylethyl.

The compounds of the formula (Ia) can likewise be obtained by the processes described in EP-A-382 173, DE-A 4 317 432, DE-A 4 317 457, DE-A 4 317 458, EP-A-634 408, EP-A-718 293, EP-A-872 481, EP-A-685 469, EP-A-626 375, EP-A-664 297, EP-A-669 343, EP-A-787 141, EP-A-865 498, EP-A-903 347.

The compositions according to the invention are suitable for controlling pathogenic endoparasites encountered in humans and in animal husbandry and livestock breeding, in productive livestock, breeding stock, zoo animals, laboratory animals, animals used in experiments, and pets, and have low toxicity towards warm-blooded animals. They are active against resistant and normally sensitive species and against all or some stages of development of the pests. By controlling the pathogenic endoparasites, it is intended to reduce disease, mortality and decreasing performance (for example in the production of meat, milk, wool, hides, eggs, honey, etc.), so that simpler and more economical animal keeping is possible by using the active compounds. The pathogenic endoparasites include Cestodes, Trematodes, Nematodes, Acantocephalides in particular:

From the order of the Pseudophyllidea, for example Diphyllobothrium spp., Spirometra spp., Schistocephalus spp., Ligula spp., Bothridium spp., Diphlogonoporus spp.

From the order of the Cyclophyllidea, for example Mesocestoides spp., Anoplocephala spp., Paranoplocephala spp., Moniezia spp., Thysanosomsa spp., Thysaniezia spp., Avitellina spp., Stilesia spp., Cittotaenia spp., Andyra spp., Bertiella spp., Taenia spp., Echinococcus spp., Hydratigera spp., Davainea spp., Raillietina spp., Hymenolepis spp., Echinolepis spp., Echinocotyle spp., Diorchis spp., Dipylidium spp., Joyeuxiella spp., Diplopylidium spp.

From the subclass of the Monogenea, for example Gyrodactylus spp., Dactylogyrus spp., Polystoma spp.

From the subclass of the Digenea, for example Diplostomum spp., Posthodiplostomum spp., Schistosoma spp., Trichobilharzia spp., Ornithobilharzia spp., Austrobilharzia spp., Gigantobilharzia spp., Leucochloridium spp., Brachylaima spp., Echinostoma spp., Echinoparyphium spp., Echinochasmus spp., Hypoderaeum spp., Fasciola spp., Fasciolides spp., Fasciolopsis spp., Cyclocoelum spp., Typhlocoelum spp., Paramphistomum spp., Calicophoron spp, Cotylophoron spp., Gigantocotyle spp., Fischoederius spp., Gastrothylacus spp., Notocotylus spp., Catatropis spp., Plagiorchis spp., Prosthogonismus spp., Dicrocoelium spp., Eurytrema spp., Troglotrema spp., Paragonimus spp., Collyriclum spp., Nanophyetus spp., Opisthorchis spp., Clonorchis spp., Metorchis spp., Heterophyes spp., Metagonimus spp.

From the order of the Enoplida, for example Trichuris spp., Capillaria spp., Trichomosoides spp., Trichinella spp.

From the order of the Rhabditia, for example Micronema spp., Strongyloides spp.

From the order of the Strongylida, for example Stronylus spp., Triodontophorus spp., Oesophagodontus spp., Trichonema spp., Gyalocephalus spp., Cylindropharynx spp., Poteriostomum spp., Cyclococercus spp., Cylicostephanus spp., Oesophagostomum spp., Chabertia spp., Stephanurus spp., Ancylostoma spp., Uncinaria spp., Bunostomum spp., Globocephalus spp., Syngamus spp., Cyathostoma spp., Metastrongylus spp., Dictyocaulus spp., Muellerius spp., Protostrongylus spp., Neostrongylus spp., Cystocaulus spp., Pneumostrongylus spp., Spicocaulus spp., Elaphostrongylus spp., Parelaphostrongylus spp., Crenosoma spp., Paracrenosoma spp., Angiostrongylus spp., Aelurostrongylus spp., Filaroides spp., Parafilaroides spp., Trichostrongylus spp., Haemonchus spp., Ostertagia spp., Marshallagia spp., Cooperia spp., Nematodirus spp., Hyostrongylus spp., Obeliscoides spp., Amidostomum spp., Ollulanus spp.

From the order of the Oxyurida, for example Oxyuris spp., Enterobius spp., Passalurus spp., Syphacia spp., Aspiculuris spp., Heterakis spp.

From the order of the Ascaridia, for example Ascaris spp., Toxascaris spp., Toxocara spp., Parascaris spp., Anisakis spp., Ascaridia spp.

From the order of the Spirurida, for example Gnathostoma spp., Physaloptera spp., Thelazia spp., Gongylonema spp., Habronema spp., Parabronema spp., Draschia spp., Dracunculus spp.

From the order of the Filariida, for example Stephanofilaria spp., Parafilaria spp., Setaria spp., Loa spp., Dirofilaria spp., Litomosoides spp., Brugia spp., Wuchereria spp., Onchocerca spp.

From the order of the Gigantorhynchida, for example Filicollis spp., Moniliformis spp., Macracanthorhynchus spp., Prosthenorchis spp.

The livestock and breeding stock include mammals, such as, for example, cattle, horses, sheep, pigs, goats, camels, water buffalo, donkeys, rabbits, fallow deer, reindeer, fur-bearing animals, such as, for example, minks, chinchilla or racoon, birds, such as, for example chickens, geese, turkeys or ducks, reptiles and insects, such as, for example, honeybee and silkworm.

The laboratory and test animals include mice, rats, guinea pigs, golden hamsters, dogs and cats.

The pets include dogs and cats.

Administration can be effected prophylactically as well as therapeutically.

Suitable solvents are all organic solvents, for example ethanol, diethylene glycol monoethyl ether, dipropylene glycol monomethyl ether, benzyl benzoate, butyl lactate, 1,2-isopropylideneglycerol, benzyl alcohol and propylene glycol diacetate, preferably benzyl benzoate, butyl lactate, 1,2-isopropylideneglycerol, benzyl alcohol and propylene glycol diacetate, particularly preferably 1,2-isopropylideneglycerol, benzyl alcohol and propylene glycol diacetate, on their own or as mixtures.

The compositions according to the invention comprise solvents or solvent mixtures in amounts of from 95% by weight to 50% by weight, preferably from 95% by weight to 70% by weight and particularly preferably from 95% by weight to 80% by weight.

Preference is given to compositions according to the invention comprising at least 60% by weight (based on the total weight of the finished composition), preferably at least 65% by weight, of 1,2-isopropylideneglycerol. These compositions particularly preferably comprise, as further solvent, benzyl alcohol in amounts of up to 40% by weight, preferably from 10 to 30% by weight. The amounts of the solvents are, of course, chosen such that they give, together with the active compound and any auxiliaries that may be used, 100% by weight.

It may be advantageous to add further auxiliaries customary in veterinary medicine, such as, for example, thickeners, to the compositions according to the invention. Examples of thickeners are: inorganic thickeners, such as bentonites, colloidal silica, aluminium monostearate, organic thickeners, such as cellulose derivatives (in particular hydroxypropylcellulose), polyvinyl alcohols and copolymers thereof, acrylates and methacrylates.

Other suitable solvents are preservatives, in particular oxidation stabilizers. Examples include butylhydroxyanisol (BHA), butylhydroxytoluene (BHT) and ascorbic acid.

In the compositions according to the invention, the active compounds can also be present in a mixture with synergists or other compounds which are active against pathogenic endoparasites. Such active compounds are, for example, L-2,3,5,6-tetra-hydro-6-phenylimidazothiazol, benzimidazol carbamates, such as febantel, furthermore pyrantel, praziquantel and ivermectin.

Ready-to-use preparations comprise the active compounds in concentrations of 0.0001-25% by weight, preferably 0.1-20% by weight.

The compositions are prepared by mixing appropriate amounts of the components in suitable apparatus.

In general, it has been found to be advantageous to administer the composition according to the invention in amounts of from about 1 to about 100 mg of active compound per kg of body weight per day to obtain effective results. Preference is given to from 1 to 10 mg of active compound per kg of body weight.

The following examples illustrate the invention without limiting it.

### EXAMPLE 1

5 parts by weight of depsipeptide are dissolved with stirring in 66.5 parts by weight of isopropylideneglycerol and 28.5 parts by weight of benzyl alcohol. This gives a colourless clear solution.

### EXAMPLE 2

5 parts by weight of depsipeptide are dissolved with stirring in 66.5 parts by weight of propylene glycol diacetate and 28.5 parts by weight of benzyl alcohol. This gives a colourless clear solution.

### EXAMPLE 3

A solution of Example 1 is admixed with an additional 2 parts by weight of hydroxypropylcellulose.

### EXAMPLE 4

The solutions from Example 1 or 2 are applied, at a dosage of 5 mg of depsipeptide per kg of bodyweight, to the coat of the saddle of the animals infected with parasites. After two to four days, the animals are free of parasites.

| | | | | Number of | Number of |
|---|---|---|---|---|---|
| | | | | treated | parasite-free |
| Animal | | Parasite | Action | animals | animals |
| 2 | dogs | Toxocara canis | 3/3 | 2 | 2 |
| 2 | cats | Toxocara cati | 3/3 | 2 | 2 |
| 2 | dogs | Ancylostoma caninum | 3/3 | 2 | 2 |

### EXAMPLE 5

The solution from Example 3 is, at a dosage of 5 mg of active compound/kg of bodyweight, applied to the saddle of cattle infected by Cooperia oncophara. The worm infection is reduced by 99%.

1. Compositions, comprising cyclic depsipeptides on their own or as a mixture with other active compounds, characterized in that they comprise a solvent or a solvent mixture and that these compositions are suitable for topical administration in animals.

2. Compositions according to claim 1, characterized in that they comprise 1,2-isopropylideneglycerol.

3. Compositions according to claim 1, characterized in that they comprise 1,2-isopropylideneglycerol and benzyl alcohol and/or propylene glycol diacetate.

4. Compositions according to claim 1, characterized in that they comprise benzyl alcohol and propylene glycol diacetate.

5. Process for preparing the compositions according to claims 1 to 4, characterized in that the active compounds are mixed with the solvents and, if appropriate, further auxiliaries.

6. Use of compositions according to claims 1 to 4 for controlling endoparasites.
